(19) United States
(12) Patent Application Publication
(10) Pub. No.: US 2019/0349815 A1
(43) Pub. Date: Nov. 14, 2019

(54) UPLINK BANDWIDTH PART SWITCHING

(71) Applicant: NOKIA TECHNOLOGIES OY, Espoo (FI)

(72) Inventors: Esa TIIROLA, Kempele (FI); Kari HOOLI, Oulu (FI); Timo LUNTTILA, Espoo (FI); Karol SCHOBER, Helsinki (FI)

(21) Appl. No.: 15/977,562

(22) Filed: May 11, 2018

(51) Int. Cl. H04W 28/20; H04W 28/26; H04W 72/04; H04W 72/12

(52) U.S. Cl. CPC H04W 28/20; H04W 28/26; H04W 74/0816; H04W 72/1205; H04W 72/0453

(57) ABSTRACT

Various communication systems may benefit from improved user equipment bandwidth allocation. For example, it may be helpful to improve user equipment bandwidth part switching for uplink transmissions. A method may include determining at a user equipment a need for retuning a radio frequency based on a received downlink transmission bandwidth. The method may also include determining at the user equipment a time for the retuning of the radio frequency. In addition, the method may include retuning at the user equipment the radio frequency at the determined time. Further, the method may include transmitting data from the user equipment to a network entity using the retuned radio frequency.

### BACKGROUND

### Field

Various communication systems may benefit from improved user equipment bandwidth allocation. For example, it may be helpful to improve user equipment bandwidth part switching for uplink transmissions.

### Description of the Related Art

In third generation partnership project (3GPP) technology, such as such as Long Term Evolution (LTE), licensed assisted access (LAA) may have two defined channel accessing, listen before talk (LBT) procedures, that is channel access procedures. In type 1 LBT, a user equipment (UE) or a network node, such as a base station, generates a random number N that can be uniformly distributed over a contention window. The size of contention window depends on the channel access priority class of the traffic the node is attempting to transmit. Once the network node or the UE has measured the channel to be vacant for N times, the network node or the UE may occupy the channel with a transmission. To align the transmission with LTE subframe boundary, the network node or UE may resort to self-deferral during the LBT procedure.

In type 2 LBT, instead of relying on a random number N of vacant subframes, network node or the UE can perform a single channel measurement in time intervals of 25 microseconds (μs) before an uplink transmission. For a physical uplink shared channel (PUSCH), type 2 LBT may be performed when a network entity, such as an eNB, shares the channel occupancy time (COT) of the network entity with the UE. In other words, once eNB has obtained access to the channel, the eNB allows one or more UEs to use a portion of the channel occupancy time for uplink transmissions. UE uplink transmission using type 2 LBT within a network entity acquired COT may also be used in unlicensed fifth generation (5G) or New Radio (NR) technology.

In NR technology, a single network entity, such as a 5G or NR NodeB (gNB), or a UE may occasionally access a wide bandwidth, comprising a 20 megahertz (MHz) channel, or very wide bandwidth comprising multiple 20 MHz channels. Wideband is therefore used in unlicensed NR operations. Both carrier aggregation and bandwidth part (BWP) mechanisms are supported in wideband operations.

### SUMMARY

According to certain embodiments, an apparatus may include at least one memory including computer program code, and at least one processor. The at least one memory and the computer program code may be configured, with the at least one processor, to cause the apparatus at least to determine a need for retune a radio frequency based on a received downlink transmission bandwidth. The at least one memory and the computer program code may also be configured, with the at least one processor, to cause the apparatus at least to determine a time for the retuning of the radio frequency. In addition, the at least one memory and the computer program code may also be configured, with the at least one processor, to cause the apparatus at least to retune the radio frequency at the determined time. Further, the at least one memory and the computer program code may also be configured, with the at least one processor, to cause the apparatus at least to transmit data to a network entity using the retuned radio frequency.

According to certain embodiments, a method may include determining at a user equipment a need for retuning a radio frequency based on a received downlink transmission bandwidth. The method may also include determining at the user equipment a time for the retuning of the radio frequency. In addition, the method may include retuning at the user equipment the radio frequency at the determined time. Further, the method may include transmitting data from the user equipment to a network entity using the retuned radio frequency.

An apparatus, in certain embodiments, may include means for determining a need for retuning a radio frequency based on a received downlink transmission bandwidth. The apparatus may also include means for determining a time for the retuning of the radio frequency. In addition, the apparatus may include means for retuning the radio frequency at the determined time. Further, the apparatus may include means for transmitting data to a network entity using the retuned radio frequency.

According to certain embodiments, a non-transitory computer-readable medium encoding instructions that, when executed in hardware, perform a process. The process may include determining at a user equipment a need for retuning a radio frequency based on a received downlink transmission bandwidth. The process may also include determining at the user equipment a time for the retuning of the radio frequency. In addition, the process includes retuning at the user equipment the radio frequency at the determined time. Further, the process includes transmitting data from the user equipment to a network entity using the retuned radio frequency.

According to certain other embodiments, a computer program product may encode instructions for performing a process. The process may include determining at a user equipment a need for retuning a radio frequency based on a received downlink transmission bandwidth. The process may also include determining at the user equipment a time for the retuning of the radio frequency. In addition, the process includes retuning at the user equipment the radio frequency at the determined time. Further, the process includes transmitting data from the user equipment to a network entity using the retuned radio frequency.

An apparatus, according to certain embodiments, may include circuitry for determining a need for retuning a radio frequency based on a received downlink transmission bandwidth. The apparatus may also include circuitry for determining a time for the retuning of the radio frequency. In addition, the apparatus may include circuitry for retuning at the user equipment the radio frequency at the determined time. Further, the apparatus may include circuitry for transmitting data to a network entity using the retuned radio frequency.

According to certain embodiments, an apparatus may include at least one memory including computer program code, and at least one processor. The at least one memory and the computer program code may be configured, with the at least one processor, to cause the apparatus at least to determine a time for retuning a radio frequency at a user equipment. The at least one memory and the computer program code may also be configured, with the at least one processor, to cause the apparatus at least to indicate the time for the retuning of the radio frequency to the user equipment. In addition, the at least one memory and the computer program code may be configured, with the at least one processor, to cause the apparatus at least to receive data from the user equipment using the retuned radio frequency.

According to certain embodiments, a method may include determining at a network entity a time for retuning a radio frequency at a user equipment. The method may also include indicating the time for the retuning of the radio frequency to the user equipment. In addition, the method may include retuning at the user equipment the radio frequency at the determined time. Further, the method may include receiving data at the network entity from the user equipment using the retuned radio frequency.

An apparatus, in certain embodiments, may include means for determining a time for retuning a radio frequency at a user equipment. The apparatus may also include means for indicating the time for the retuning of the radio frequency to the user equipment. In addition, the apparatus may include means for receiving data from the user equipment using the retuned radio frequency.

According to certain embodiments, a non-transitory computer-readable medium encoding instructions that, when executed in hardware, perform a process. The process may include determining at a network entity a time for retuning a radio frequency at a user equipment. The process may also include indicating the time for the retuning of the radio frequency to the user equipment. In addition, the process may include receiving data at the network entity from the user equipment using the retuned radio frequency.

According to certain other embodiments, a computer program product may encode instructions for performing a process. The process may include determining at a network entity a time for retuning a radio frequency at a user equipment. The process may also include indicating the time for the retuning of the radio frequency to the user equipment. In addition, the process may include receiving data at the network entity from the user equipment using the retuned radio frequency.

An apparatus, according to certain embodiments, may include circuitry for determining a time for retuning a radio frequency at a user equipment. The apparatus may also include circuitry for indicating the time for the retuning of the radio frequency to the user equipment. In addition, the apparatus may include circuitry for receiving data from the user equipment using the retuned radio frequency.

### BRIEF DESCRIPTION OF THE DRAWINGS:

For proper understanding of the invention, reference should be made to the accompanying drawings, wherein:

FIG. 1 illustrates an example of a diagram according to certain embodiments.

FIG. 2 illustrates an example of a diagram according to certain embodiments.

FIG. 3 illustrates an example of a diagram according to certain embodiments.

FIG. 4 illustrates an example of a diagram according to certain embodiments.

FIG. 5 illustrates an example of a diagram according to certain embodiments.

FIG. 6 illustrates an example of a method according to certain embodiments.

FIG. 7 illustrates an example of a method according to certain embodiments.

FIG. 8 illustrates an example of a system according to certain embodiments.

### DETAILED DESCRIPTION

Certain embodiments include UE BWP switching for uplink transmission in an NR unlicensed (NR-U) band scenario. For example, a UE may dynamically adjust its bandwidth by utilizing BWP switching when the UE is located in an NR-U cell that operates on wideband. Doing so may allow for more flexible signaling and may help to facilitate a UE bandwidth retuning or adjusting during, or in response to, a downlink transmission burst, while also supporting useful transmission and reception of the signal with small gaps within the COT. For example, the transmission burst may include a downlink transmission or an uplink transmission, or both, as well as corresponding switching time gaps to allow for switching between downlink and uplink transmissions. The embodiments discussed below are directed to an improvement to computer-related technology, and help to conserve resources of the network itself, as well as the UE. This can help to elongate the battery life of the UE, while increasing the efficiency of the network, and reducing network resource costs.

Conventional carrier aggregation may offer several benefits. For example, carrier aggregation may offer frequency domain flexibility since aggregated carriers may not need to be adjacent, and may be widely apart. Using carrier aggregation therefore provides for improved diversity for channel access. The use of carrier aggregation also allows for individual carriers to operate standalone, in terms of downlink (DL) control and hybrid automatic repeat request (HARQ) processes. Each carrier may employ its own LBT, which means increased channel access agility.

In some embodiments, carrier aggregation may be used for supporting unlicensed NR technology, in addition to facilitating the LAA operation with the NR licensed carrier. While using carrier aggregation may have various advantages, multiple radio frequency (RF) chains may be required, thereby increasing the price of UE transceivers. Carrier aggregation may also increase UE power consumption and may exhibit considerable latency as related to component carrier activation or deactivation.

As discussed above, the UE may be instructed to operate on a specific part of a network entities bandwidth referred to as a BWP. In certain embodiments, up to four BWPs may be configured separately for uplink and downlink transmissions. Some radio resource control (RRC) parameters in NR, for example, may be configured on a BWP. Each BWP may have a separately configured subcarrier spacing (SCS), cyclic prefix, bandwidth in terms of contiguous physical resource blocks (PRBs), and/or location of a bandwidth in a cell's total bandwidth. K0, K1 and K2 may be values that define the time offset from downlink assignment reception to the beginning of physical data shared channel (PDSCH) transmissions, from the end of PDSCH to an HARQ acknowledgment (ACK) transmission time, and from UL grant reception to the start of PUSCH transmission, respectively. In some embodiments that utilize an unpaired spectrum, for example those embodiments that utilize time division duplex (TDD), uplink and downlink BWPs may be paired, in which case the center frequency of both uplink and downlink BWPs of a UE may be required to be the same. One of the BWPs may be defined as a default BWP to help facilitate UE battery saving using inactivity timer switching.

In certain embodiments, the UE may have only one BWP active at a time. Active BWP may be indicated by a field in the downlink control information (DCI) or by RRC signaling. BWP switching may occur after the UE has received the signaling changing the active BWP. BWP switching may mean that the UE changes or adjusts frequency and/or time resources in order to receive or send transmissions in a different part of the allowable bandwidth. Part of the bandwidth part switching, may include retuning the center frequency or bandwidth of the radio frequency receiver or transmitter used by the UE. The UE, in some embodiments, may also fall-back to default BWP after a configured period of inactivity.

Utilizing BWP and/or BWP switching may provide for an alternative wideband mechanism when accessing an unlicensed spectrum on adjacent 20 MHz channels. BWP, for example, may provide savings in the UE cost by reducing the number of radio frequency (RF) transmitter or receiver chains. A single RF transmitter or receiver chain and a Fast Fourier Transformation (FFT) processing can be used to access wide bandwidth, such as 80 MHz, 160 MHz, 5 gigahertz (GHz), or 6 GHz unlicensed bands. In certain embodiments in which the BWP switching time may be shorter than the component carrier deactivation or activation time, the UE may be switched to a narrower BWP, and subsequently back to wideband BWP, thereby saving UE battery and improving throughput more than a slower component carrier (CC) deactivation or activation. On the other hand, NR BWP switching time, which may take up to 600 or 2000 μs, depending on whether the UE is slower or faster, for example, may have a different order of magnitude than a single clear channel assessment slot in the LBT procedure, which may have a length of 9 μs. The balancing between the UE throughput and the battery consumption may pose constraints on how BWP operations and LBT may interact.

Channel contention, in some embodiments, may be used to create more efficient wideband operations. NR unlicensed spectrum may support a 20 MHz grid for LBT operations in a 5 GHz unlicensed band. Wider LBT bandwidths may also be supported, in certain embodiments, for other higher frequency unlicensed bands, or for potential new unlicensed bands, for example, a 6 GHz band. LAA LBT operations in other technologies, such as LTE or wireless land area network (WLAN), may also utilize 20 MHz channels, which means that the NR unlicensed spectrum may be compatible with other 3GPP or non-3GPP technology.

In certain embodiments that utilize NR unlicensed wideband operations, which may be larger than 20 MHz, the operations may be performed in a 5 GHz unlicensed spectrum. A large FFT size of 4 k FFT (where 4 k denotes the FFT size of 4096) may be utilized, while a maximum number of PRBs per BWP may be 275. Accordingly, when the UE switching is based on the 4 k FFT, the number of subcarriers available for the UE may be calculated as follows: 275 PRB*12 subcarriers/PRB=3300 subcarriers. A large SCS, such as 30 kHz or 60 kHz, may also be used.

The NR carrier bandwidth, for example, may be 40 MHz, 80 MHz or 160 MHz. Sub-bands may be one or more adjacent channels on an unlicensed carrier, which may have a bandwidth of 20 MHz. In some embodiments, sub-bands may be aligned with the bandwidth for LBT operations. Sub-band may also be equal to a bandwidth of a single LBT, for example a bandwidth of 20 MHz, or multiple LBT bandwidths, such as 40 MHz. All sub-bands may have the same bandwidth, or different sub-band bandwidths may be combined. For example, an 80 MHz carrier bandwidth may include three sub-bands of 20, 20, and 40 MHz. In certain embodiments, for a large FFT size of 4 k, 8 sub-band carriers each having a size of 20 MHz may be used when the SCS is equal to 60 kHz. In other embodiments, for a large FFT size of 4 k, 4 sub-band carriers each having a size of 20 MHz may be used when the SCS is equal to 30 kHz, while 2 sub-band carriers each having a size of 20 MHz may be used when the SCS is equal to 15 kHz. In certain embodiments, a BWP may include contiguous set of PRBs. Based on that, adjacent sub-bands, which may each have a size of 20 MHz, for example, may be the baseline approach for bandwidth adaptation or adjustment. In some embodiments, non-contiguous allocations of sub-bands may be considered and/or supported. Non-contiguous allocation may be a feasible assumption at least for the network entity transmitter, such as a gNB transmitter.

When operating according to unlicensed band regulations in a NR-U scenario, a network entity, such as gNB, may perform LBT before transmitting a downlink transmission burst in the cell. To ensure fair coexistence with other systems, NR unlicensed may support a sub-band LBT with at least a 20 MHz resolution. Transmission bandwidth combinations for the network entity after sub-band specific LBT, for example, may have an overall bandwidth 80 MHz, and an allocation of 20 MHz sub-bands.

In certain embodiments, the network entity, such as gNB, may maintain a constant bandwidth based on a network carrier, while the UE may operate on a specific BWP. In NR-U, the gNB may obtain channel access on a wide bandwidth, for example a bandwidth of 80 MHz. While performing LBT, or even before performing LBT, gNB may observe results that it may gain channel access only on a part of the wide bandwidth. For example, even if the gNB has access to 80 MHz, it may only gain access to 40 of the available 80 MHz.

While reducing its bandwidth, the gNB may or may not adjust the radio frequency receiver or transmitter configuration, such as center of frequency, analog filters, and/or digital filters, in order to meet regulatory rules defined for out-of-band emissions. In certain embodiments, the gNB may decide on and perform the transmission bandwidth adaptation during the LBT process. The adapting of adjusting of the bandwidth may occur either at the end of the LBT process or at any point before the end of the LBT process.

Transmission bandwidth (TX BW) may be a part of the spectrum on which the network entity transmits after LBT. TX BW may be equal to the carrier bandwidth or be a portion of carrier bandwidth, such as one or more sub-bands, based on the outcome of LBT. Certain embodiments may utilize interference avoidance based on dynamic bandwidth adaptation. In other words, the gNB may initially start with a bandwidth of 80 MHz. Interference may then occur on the two lower 20 MHz sub-bands, and the network entity may decide to switch to using the two interference-free sub-bands, which may be the higher 20 MHz sub-bands. Although the bandwidth switching would lead the network entity to transmit on a narrower bandwidth than the UE would receive, the network entity does not necessarily require the UE to retune the radio frequency of the UE in order to receive the downlink reception. Retuning the radio frequency may include changing the radio frequency bandwidth and/or center frequency. Without retuning, however, the UE may remain more vulnerable to interference. On the other hand, it may be difficult for the UE to facilitate rapid retuning of the radio frequency at the time when the downlink transmission from the network entity starts.

From an uplink transmission point of view, meaning from the point of view of the UE transmitting data to the network entity, it may be difficult to perform flexible bandwidth operations. Prior to the start of a downlink transmission, the UE may only be aware of the wide carrier bandwidth on which the network entity may transmit, but not the actual Tx BW. The UE may therefore use the wide carrier bandwidth to detect downlink a transmission burst, and in case the actual Tx BW is less than the carrier bandwidth, the UE may end up receiving some interfering signals. In some embodiments, the network entity may share COT only on the Tx BW on which it has acquired channel access. In other words, the network entity may schedule transmissions on the physical uplink shared channel (PUSCH) using type 2 LBT, within the bandwidth of the current downlink transmission burst. Before starting the PUSCH transmission, with a type 2 LBT, the UE may need to adjust its own bandwidth and center frequency to correspond to the bandwidth of the current downlink transmission burst or PUSCH allocation. For low cost UEs, however, meeting the emission mask may not be feasible without adjusting their bandwidth and center frequency. Certain embodiments, therefore, may help to facilitate a dynamic bandwidth retuning operation for uplink transmissions.

During BWP switching, particularly before or during the retuning of the radio frequency, the UE may not be expected to either transmit or receive. In certain embodiments, the BWP transmission time may be 600 μs or more, which may not include a radio resource management (RRM) delay following the BWP switch. The RRM delay, for example, may include at least one of automatic gain control, time and/or frequency synchronization, or channel estimation. Of the 600 μs BWP transmission time, about 250 μs may be for retuning of the radio frequency itself, while the rest is the preparation for retuning, such as an interpretation of a dynamic switching command In certain embodiments, even though the transition period is slot boundary aligned, it may be possible to perform the radio frequency retuning in any part of the slot.

In some embodiments, the slot duration may be 250 μs with 60 kHz SCS, while the slot duration may be 500 μs with 30 kHz SCS, respectively. In LTE LAA, the network entity may run the whole type 1 LBT procedure on a vacant channel for Channel Access Priority Class 3 traffic in ˜200 μs or so Channel Access Priority Class 3 defines three sizes for a contention window 15, 31, and 63 slots corresponding to 135 μs, 279 μs, and 667 μs, given a CCA slot of 9 μs. A 200 μs gap on a transmission, however, may be considerable for unlicensed operations during which the acquired channel access may be lost. Such a long gap in transmission may therefore not be desirable.

In an NR licensed band operation, the UE may switch its active BWP or retune its radio frequency based on an indication in a downlink assignment or an uplink grant. For example, the indication may be in the form of a DCI, and may take the form of DCI format 0_1 or DCI 1_1, being the configurable, non-fallback DCI format for PUSCH and PDSCH scheduling, respectively, including a BWP index field as defined in TS 38.212. 3GPP TS 38.212 is hereby incorporated by reference in its entirety. In yet another embodiment, the UE may switch its active BWP or retune its radio frequency based on RRC signaling.

In certain embodiments, a UE may not expected to either receive downlink signals or transmit uplink signals during the transition time of active downlink or uplink BWP switch. For DCI-based active BWP switch, the transition time of active downlink or uplink BWP switch is the time duration from the end of last orthogonal frequency domain multiplexing (OFDM) symbol of the physical downlink control channel (PDCCH) carrying the active BWP switch DCI until the beginning of a slot indicated by KO in the active downlink BWP switch DCI or by K2 in the active uplink BWP switch DCI.

For timer-based active BWP switch, on the other hand, the transition time of active downlink or uplink BWP switch may be the time duration from the beginning of the subframe (FR1) or from the beginning of the half-subframe (FR2) immediately after a BWP timer expires until the beginning of a slot. The slot may be one in which a UE may receive downlink signals or transmit uplink signals in the default downlink BWP for a paired spectrum, or the default downlink or uplink BWP for an unpaired spectrum.

The network entity, such as a gNB, however may not be provided with sufficient control on the UE BWP transmission time to allow for efficient NR-U wideband operation. For example, after sending the uplink grant with a BWP switch, no PDCCH or PDSCH can be scheduled to the UE during the several consecutive slots of downlink bursts. In Dual Connectivity LAA and/or in embodiments involving stand-alone NR-U, a UE may report HARQ feedback via the unlicensed NR band. Hence, the UE may perform the BWP switch or the radio frequency tuning for the downlink assignments. To do so, the network entity may reserve BWP transition time between the downlink assignment and the PDSCH transmissions.

Constructing continuous transmission under the above BWP switching related scheduling restrictions may complicate scheduling, especially since a NR-U cell may serve one or more UEs in a given COT. Certain embodiments, therefore, may help to provide more flexible signaling to facilitate UE bandwidth adjustment or radio frequency retuning during the downlink transmission burst, while also supporting useful transmissions and/or receptions of the signal with only a small gap within the COT. Doing so may provide significant improvements to the functioning of the network and/or to the functioning of the network entities and UEs within the network.

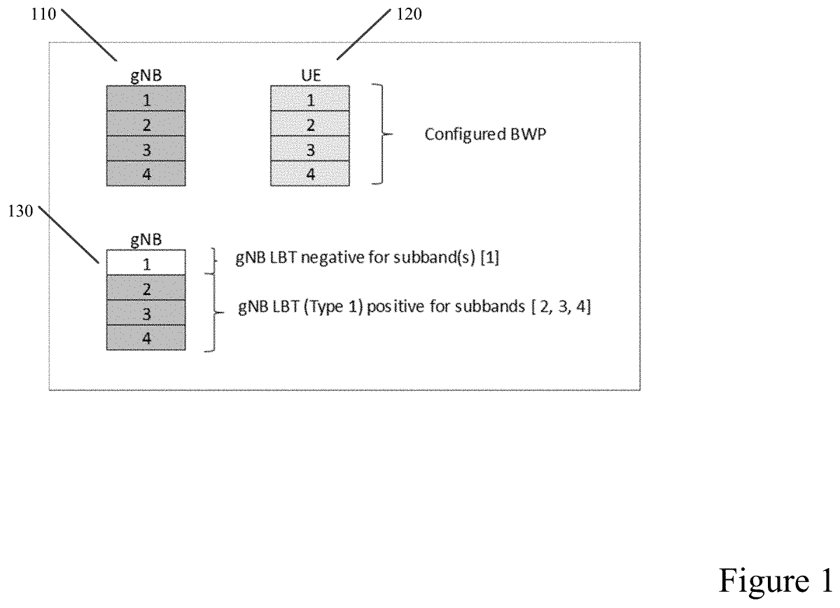

FIG. 1 illustrates an example of a diagram according to certain embodiments. In particular, FIG. 1 illustrates a network entity, such as gNB 110, may have access to the entire bandwidth, which may be a wide bandwidth. The entire bandwidth of gNB 110 may include 4 sub-bands, and the configured BWP of UE 120 may allow UE 120 to access the entire bandwidth. As shown by gNB 130 in FIG. 1, however, the network entity may not obtain channel access on the whole carrier bandwidth, on which it performs sub-band based LBT. While gNB 130 may only access three sub-bands, due to performing LBT in sub-bands 2, 3, and 4, the UE may be configured with 4 sub-bands. In other words, the UE may be configured with N sub-bands, the network entity may occupy M out of N sub-bands, where M is less than N. FIG. 1, therefore, illustrates certain embodiments in which the UE is configured with more BWPs than the network entity has access to.

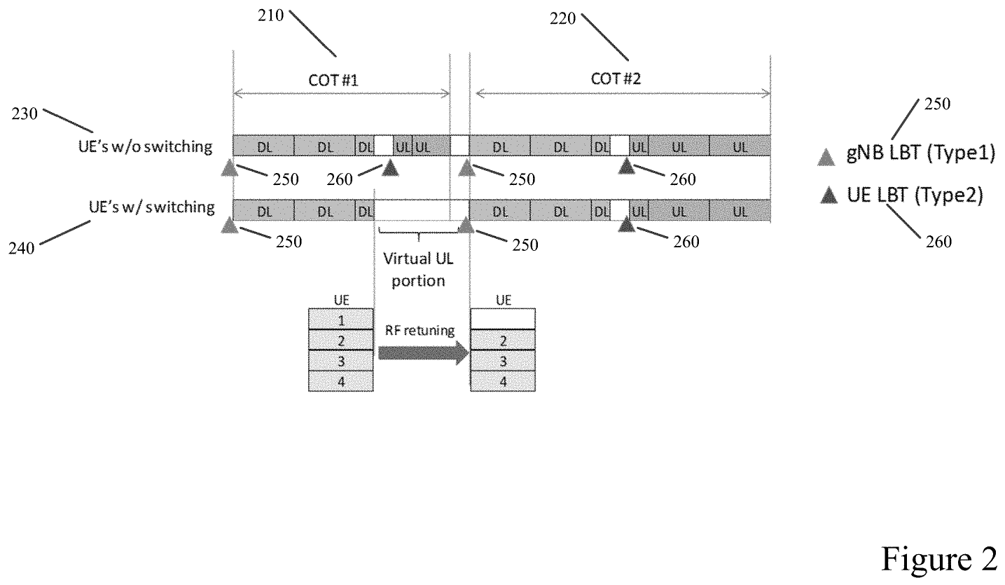

FIG. 2 illustrates an example of a diagram according to certain embodiments. In particular, FIG. 2 illustrates that the user equipment performs retuning of the radio frequency during a virtual uplink portion of the first COT 210, referred to as COT#1 210. In COT#1 210, a network entity, such as gNB, may indicate to the UE a number of sub-bands with positive LBT. In other words, the UE may receive a downlink transmission on a bandwidth from the network entity. Based on the downlink transmission or the bandwidth of the downlink transmission, the UE may determine the number of sub-bands being used by the gNB.

In certain embodiments, the UE may receive an indication from the network entity, which may be either implicit or explicit. The indication may be used by the UE to determine a need for retuning a radio frequency based on the indication. The Implicit indication, for example, may be based on the sub-band specific preamble, such as a channel state information reference signal (CSI-RS), a PDCCH, a demodulation reference signal (DMRS), and/or a wake-up signal. The explicit indication, for example, may be an information element included in the downlink assignment or in group common PDCCH (GC-PDCCH). The explicit indication may also be UE-specific, and may include further reduced bandwidth and/or a number of sub-bands for UE's experiencing interference on some of the sub-bands with positive LBT, due to a hidden node issue. The hidden nodes issue may occur, for example, when a transmitter finds that a given channel is unoccupied, but there exists interference at the intended receiver. The hidden node sub-bands of a UE, can be identified, for example, based on a previously reported CSI measurement.

Based on the indication or the downlink transmission bandwidth, the UE may determine a need for retuning a radio frequency. The retuning, for example, may occur within the current COT#1 210. In some examples, COT#1 210 may be a downlink only COT for UEs that need to perform radio frequency retuning before the uplink transmission. The UE may receive transmissions during COT#1 210 using configured NR BWP, which may be in all of the sub-bands in the configured bandwidth. If the UE's BWP is narrower than the bandwidth of the network entity, the network entity may only serve the UE on the sub-bands belonging to the UEs BWP. In certain embodiments, an uplink transmission at the end of COT#1, during a virtual uplink portion, may be supported for UEs that may not need to perform radio frequency retuning within COT#1. In other words, configured BWP of the UE may be located within M sub-bands used by network entity.

COT#1 210 may include information when a UE should perform radio frequency retuning. The UE may determine a time for the retuning, also referred to as switching time information, based on the downlink transmission or the bandwidth of the downlink transmission. For example, the time may be determined based on a structure of the transmission burst, such as the indicated COT structure, or on a received indication, such as GC-PDCCH. The radio frequency retuning time may be the same for all user equipment performing radio frequency retuning. In other words, the time for the retuning of the radio frequency aligns with retuning performed by at least another user equipment. In certain embodiments, the UE may not receive PDSCH during either COT#1 210 or COT#2 220, nor transmit uplink signals during COT#2 220. In such embodiments, the UE may not need to perform radio frequency retuning.

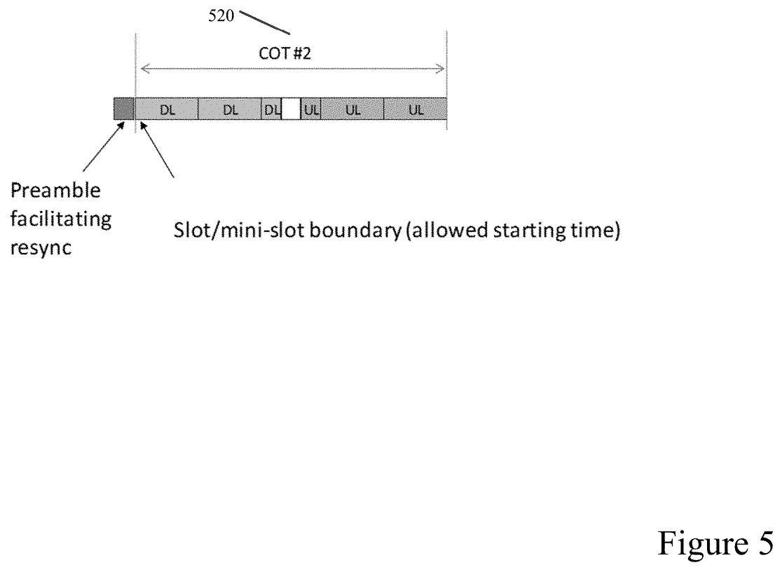

In certain embodiments, as shown in FIG. 2, the time for retuning the radio frequency may start at the end of the downlink portion of COT#1 210. The time for retuning may be seen as virtual uplink portion of the COT#1 210 from the point of view of the UE performing the retuning of the radio frequency. In some embodiments, the network entity may indicate when the downlink portion of the COT#1 ends. The indication, for example, may be explicit in the form of a GC-PDCCH. The time for retuning may start at the end of the downlink portion, at the latest, and the time for retuning ends at the beginning of COT#2, as the latest. In certain embodiments, sufficient means for performing frequency and/or time synchronization may be available at the beginning of COT#2 220, as shown in FIG. 5. In such embodiments, the allowed switching time may end at the beginning of the synchronization signal of COT#2 220.

As shown in FIG. 2, COT#2 220 may start with a downlink portion. At the beginning of COT#2 220, there may be sufficient reference signal to perform frequency and/or time synchronization. Depending on the LBT strategy, the UE may or may not know the actual starting position of COT#2 220. In certain embodiments, during COT#2 220, the UE may receive and/or transmit data using the new BWP configuration defined based on the indication received during COT#1 210. COT#2 220 may include short PUCCH and an opportunity for PUSCH transmission.

After COT#2 220, the UE retuning of the radio frequency or BWP adjustment based on the bandwidth of the downlink transmission, for example, may be dynamic or semi-static. In certain embodiments that involve dynamic retuning, the UE may continue operation according to the configured BWP after COT#2 220. In other words, downlink transmission following COT#2 220 may be considered as a next COT#1, meaning that the UE starts with the entire BWP being the configured BWP. In some embodiments, the UE may benefit from dynamic retuning of the radio frequency based on the downlink transmission bandwidth, such as the network entity LBT. In certain embodiments that involve semi-static retuning, the UE may continue operation according to retuned radio frequency or adjusted BWP after COT#2 220, meaning that the UE may not perform retuning between COT#2 and COT#1. In such embodiments, retuned radio frequency may be minimized. In certain other embodiments, the network entity may indicate to the UE which option to use, whether dynamic or semi-static. The indication may be conveyed to the UE, via L1 control signaling, such as DCI, or via Medium Access Control (MAC) signaling.

FIG. 2 illustrates an example of a UE without switching 230, meaning without radio frequency retuning, and a UE with switching 240, meaning with radio frequency retuning. For UE without switching 230, both gNB LBT type 1 250 and UE LBT type 2 260 occur in COT#1 210. For UE with switching 240, only gNB LBT type 1 250 occurs during COT#1 210, while the UE may determine radio frequency retuning in the virtual uplink portion. The UE may determine the time of the retuning based on the received downlink transmission. As shown in FIG. 2, type 1 LBT may be performed at the beginning of COT#2. Sub-band specific LBT, on the other hand, may be performed only for sub-bands used during COT#1.

In certain embodiments, the UE may determine a need for retuning a radio frequency based on a received downlink transmission bandwidth. When the bandwidth of the UE's active BWP is wider than the downlink transmission burst bandwidth, and the UE receives downlink assignment or has periodic or quasi-periodic uplink resources allocated, the UE may determine that there is a need to switch the active BWP and to perform radio frequency retuning. The UE may determine downlink transmission burst bandwidth based on a specific preamble on the sub-band. The specific preamble may be CSI-RS, PDCCH DMRS, or a wake-up signal. In another embodiment, the determination of a downlink transmission burst bandwidth may be based on an information element included in the downlink assignment and/or in a GC-PDCCH.

Once the UE determines a need for retuning a radio frequency based on a received downlink transmission bandwidth, the UE may determine a time for the retuning of the radio frequency. For example, the time may be determined based on a structure of the transmission burst or an indication received from the network entity. The structure of the downlink transmission bandwidth may be a COT structure. The transmission burst structure may include downlink and/or uplink slots of the COT, ending time of the downlink portion of COT, and/or the ending time of the COT. In other embodiments, the network entity may explicitly indicate the transmission burst structure via an information element included in GD-PDCCH.

In some embodiments, the UE may then retune the radio frequency at the determined time. As shown in FIG. 2, the radio frequency retuning may occur during the uplink portion of COT#1 and/or during a gap before the start of COT#2. The UE may then transmit data to the network entity using the retuned radio frequency. For example, as shown in FIG. 2, the UE may transmit with a narrower bandwidth (configuration/BWP) in COT#2. The time of the retuning of the radio frequency may occur after continuous or adjacent downlink slots. In other words, the time for the retuning of the radio frequency occurs after one or more adjacent downlink slots.

The UE, in certain embodiments, may have reported nodes. Thereby, at least one of BWP activation or BWP switching may be aligned and indicated jointly for a group of UEs. The time for retuning, for example, may be triggered by receiving a GC-PDCCH. The retuning may be automatically triggered by the UEs with periodic uplink transmissions. The UE, in some embodiment, may provide a reference signal, such as a common reference signal, or a preamble for UE resynchronization after retuning of the radio frequency.

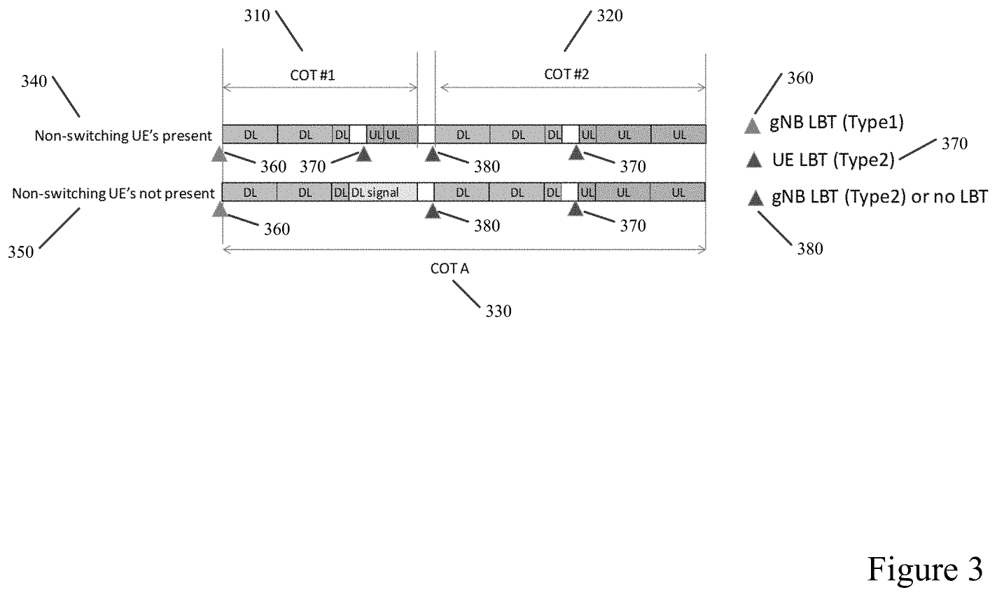

FIG. 3 illustrates an example of a diagram according to certain embodiments. In particular, FIG. 3 may illustrate an example of a COT#1 310 and a COT#2 320 being treated as a single COT A 330. FIG. 3 shows a non-switching UE 340 that may be presented, while a non-switching UE 350 may not be present. Instead of gNB LBT type 1 360 being performed at the beginning of COT#2 320, gNB LBT type 2 380 is performed or no LBT is performed. In an example embodiment in which radio frequency tuning is present 350, the UE type 2 LBT 370 is performed only at COT #2 320.

When a non-switching UE 340 is present, certain embodiment may be seen as a single network entity, such as gNB, acquiring COT with multiple switching points. In the above embodiments, it may be enough for the network entity to perform type 2 LBT, or no LBT at all, before COT#2. In other embodiments in which non-switching UEs are not present, meaning that the radio frequency of the UE are retuned, then the network entity may transmit a downlink signal, such as CSI-RS. Network entity may not perform LBT before COT#2.

In certain embodiments, HARQ-ACK feedback may be delayed for the UEs performing radio frequency tuning. The UEs performing radio frequency retuning may not transmit PUCCH during COT#1. The uplink control information (UCI) related to COT#1, such as HARQ-ACK, may be conveyed in another COT, for example COT#2, via another short PUCCH and/or via another UCI container triggered by the uplink grant. The triggering uplink grant may be a UCI multiplexed with data on PUSCH or via long PUCCH multiplexed with uplink data. From the HARQ ACK feedback, point of view, COT#1 and the downlink portion of COT#2 may be seen as a single COT. For example, a downlink assignment index counter may be reset only at the beginning of COT#1.

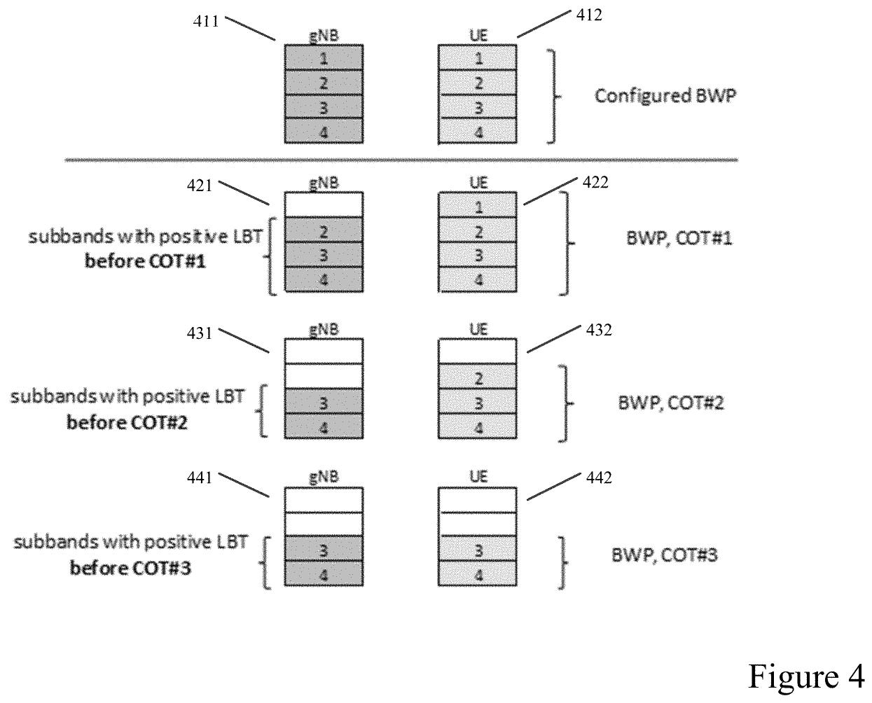

FIG. 4 illustrates an example of a diagram according to certain embodiments. In particular, FIG. 4 illustrates an example embodiment of sub-band specific LBT, for example type 1 or type 2, made before COT#2 is not all positive for all M sub-bands. COT#2 may be considered as another downlink only COT, having a functionality of COT#1 in FIG. 3, while the uplink transmission can be made only in COT#3, having the functionality of COT#2 in FIG. 3.

As can be seen in FIG. 4, the configured BWP for UE 412 may include 4 sub-bands. Similarly, gNB 412 bandwidth may also include 4 sub-bands. In COT#1, gNB 421 may only have three sub-bands with positive LBT before COT#1, while UE 422 may have four BWPs. In COT#2, gNB 431 may only have two sub-bands with positive LBT, while UE 432 may have three BWPs. In other words, in both COT#1 and COT#2 the UE BWP is larger than the bandwidth of the network entity, which means that the uplink transmission is not made on neither COT#1 nor COT#2. Before COT#3, there are two positive LBT in network entity 441, while UE 442 may have two BWPs. As shown in FIG. 4, the uplink transmission may only be made in COT#3.

Certain embodiments may involve frequency and/or time re-synchronization after the BWP switching or the retuning of the radio frequency. After performing BWP adjustment, for example right before COT#2, the UE may receive downlink reference signals for its frequency and/or time fine tuning. The UE may use PDCCH and/or PDSCH DMRS for achieving the frequency and/or time synchronization required for PDCCH/PDSCH reception. In some embodiments, at least certain DMRS may be in a predefined location in frequency and time.

FIG. 5 illustrates a diagram according to certain embodiments. In particular, as shown in FIG. 5 the network entity, for example, may include other additional reference signals before COT#2 520. This reference signals may include, for example, aperiodic CSI-RS, or additional primary synchronization signal (PSS) and/or secondary synchronization signal (SSS). In other words, as illustrated in FIG. 5, a preamble that facilitates resynchronization may be included before COT#2 520. The presence of additional downlink reference signals may be indicated at the DCI triggering the BWP switch/retuning the radio frequency, or as part of group common DCI. Having the additional reference signals before the downlink burst, such that all of the UEs in the COT have already performed the switching, has the benefit that all UEs performing BWP switching may use the same reference signal for frequency and/or time resynchronization.

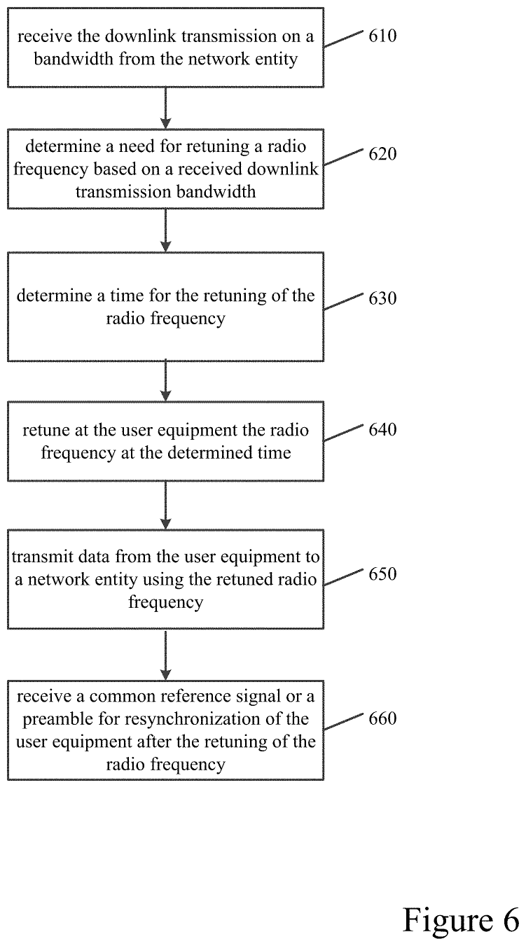

FIG. 6 illustrates an example of a method according to certain embodiments. In particular, FIG. 6 illustrates a method performed by a UE. The UE, for example, may be included in a NR-U cell. In step 610, the UE may receive the downlink transmission on a bandwidth from the network entity. The receiving of the downlink transmission, in certain embodiments, may trigger the retuning of the radio frequency. In step 620, the UE may determine a need for retuning a radio frequency based on a received downlink transmission bandwidth. The need for the retuning of the radio frequency may occur when a bandwidth part of the UE may not be included within a downlink bandwidth part of the network entity or when the bandwidth part of the user equipment is only partially included within the downlink bandwidth part of the network entity. In certain embodiments, the BWP of the network entity may be wider than the BWP of the UE. However, as the UE applies radio frequency filtering according to its BWP, the DL BWP received by the UE may be the intersection of network entity and UE BWPs. In step 630, the UE may determine a time for the retuning of the radio frequency. In certain embodiments, the time may be determined based on a structure of the transmission burst or an indication received from the network entity. The time for the retuning of the radio frequency may start at the end of the transmission burst. The transmission burst may include two or more downlink, and one or more uplink transmission portions, and corresponding switching gaps. The indication, for example, may be explicit or implicit.

In some embodiments, the time for the retuning of the radio frequency may occur after one or more adjacent downlink slots. In step 640, the UE may retune at the UE the radio frequency at the determined time. The UE may not perform any uplink transmissions before or during the retuning of the radio frequency. In certain embodiment, a non-switching UE may transmit uplink transmissions via a first uplink portion of the transmission burst. In step 650, the UE may transmit data from the UE to a network entity using the retuned radio frequency. In step 660, the UE may receive a reference signal or a preamble for resynchronization before a next downlink portion of a transmission burst.

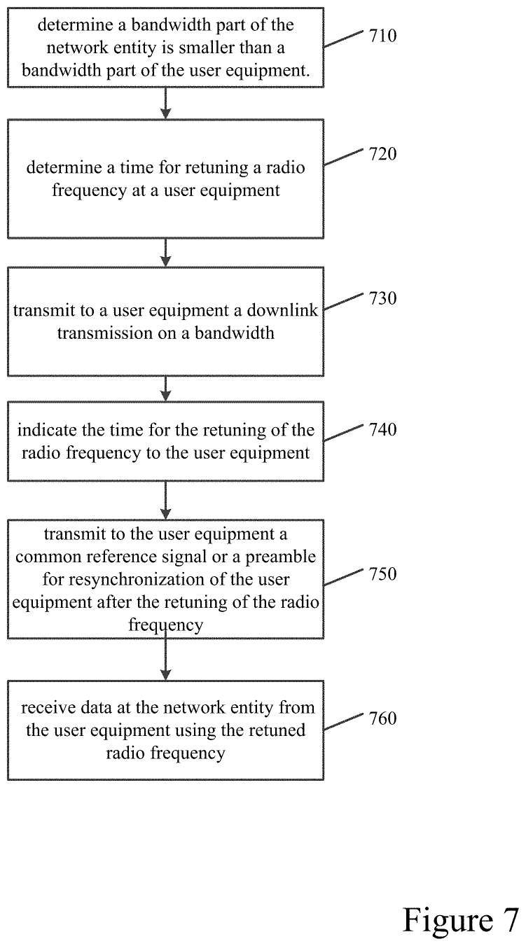

FIG. 7 illustrates an example of a method according to certain embodiments. In particular, FIG. 7 illustrates a method performed by a network entity, for example a gNB. The gNB, for example, may operate in a NR-U cell. In step 710, the network entity may determine that determine a bandwidth part of the network entity is smaller than a bandwidth part of the UE. The determining of the time for the retuning of the radio frequency may occur when the bandwidth part of the network entity is smaller than the bandwidth part of the network entity. In step 720, the network entity may determine at a network entity a time for retuning a radio frequency at a UE. The time may include at least one of a start time and a length of time for the retuning of the radio frequency at the UE. The time for the retuning of the radio frequency may also align with retuning performed by another UE. In some other embodiments, the time for the retuning of the radio frequency may occur after one or more adjacent downlink slots.

In step 730, the network entity may transmit a downlink transmission on a bandwidth to the UE. The downlink transmission may trigger the retuning of the radio frequency. In step 740, the network entity may indicate the time for the retuning of the radio frequency to the UE. In step 750, the network entity may transmit to the UE a reference signal or a preamble for resynchronization of the UE before a next downlink portion of a transmission burst. In step 760, the network entity may receive data from the UE using the retuned radio frequency. In certain embodiments, the network entity may perform either a type 2 listen before talk or no listen before talk before a second downlink portion of a transmission burst.

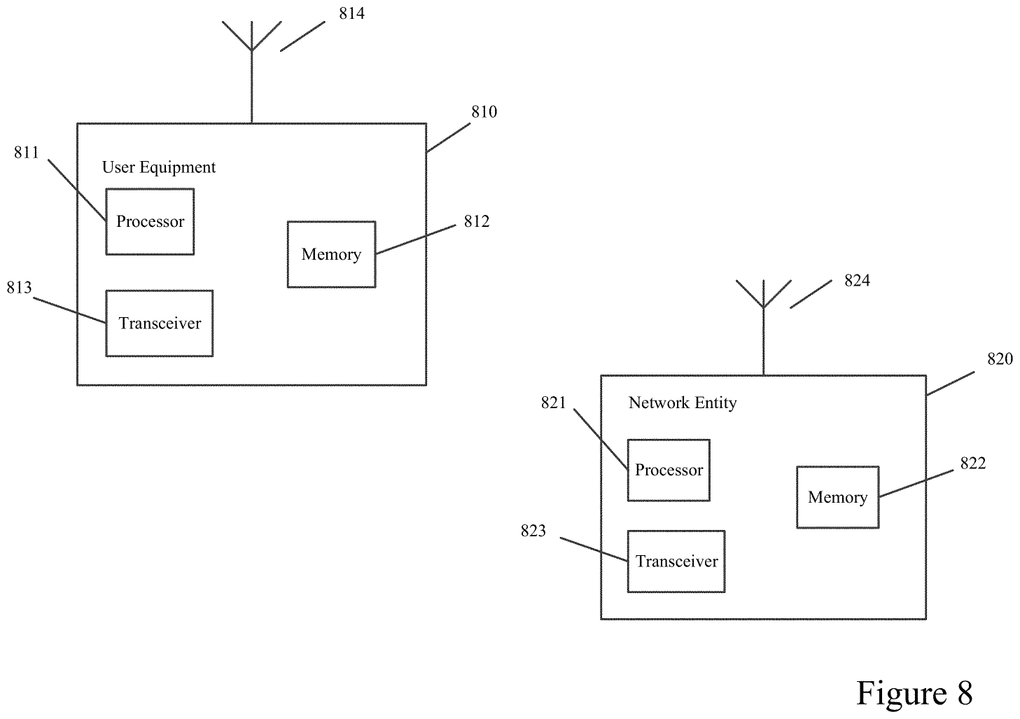

FIG. 8 illustrates a system according to certain embodiments. It should be understood that each signal or block in FIGS. 1-7 may be implemented by various means or their combinations, such as hardware, software, firmware, one or more processors and/or circuitry. In one embodiment, a system may include several devices, such as, for example, network entity 820 or user equipment (UE) 810. The system may include more than one UE 810 and more than one network entity 820. Network entity 820 may be a network node, a base station, an access point, an access node, a gNB, an eNB, a server, a host, or any other network entity that may communicate with the UE.

Each of these devices may include at least one processor or control unit or module, respectively indicated as 811 and 821. At least one memory may be provided in each device, and indicated as 812 and 822, respectively. The memory may include computer program instructions or computer code contained therein. One or more transceiver 813 and 823 may be provided, and each device may also include an antenna, respectively illustrated as 814 and 824. Although only one antenna each is shown, many antennas and multiple antenna elements may be provided to each of the devices. Other configurations of these devices, for example, may be provided. For example, network entity 820 and UE 810 may be additionally configured for wired communication, in addition to wireless communication, and in such a case antennas 814 and 824 may illustrate any form of communication hardware, without being limited to merely an antenna.

Transceivers 813 and 823 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner In other words, division of labor may vary case by case. One possible use is to make a network entity deliver local content. One or more functionalities may also be implemented as virtual application(s) in software that can run on a server.

A user device or UE 810 may be a mobile station (MS) such as a mobile phone or smart phone or multimedia device, an IoT cellular device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. In other embodiments, the user equipment may be replaced with a machine communication device that does not require any human interaction, such as a sensor, meter, or robot.

In some embodiments, an apparatus, such as a user equipment or a network entity, may include means for carrying out embodiments described above in relation to FIGS. 1-7. In certain embodiments, at least one memory including computer program code can be configured to, with the at least one processor, cause the apparatus at least to perform any of the processes described herein.

Processors 811 and 821 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 812 and 822 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 820 or UE 810, to perform any of the processes described above (see, for example, FIGS. 1-7). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

In certain embodiments, an apparatus may include circuitry configured to perform any of the processes or functions illustrated in FIGS. 1-7. Circuitry, in one example, may be hardware-only circuit implementations, such as analog and/or digital circuitry. Circuitry, in another example, may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The above embodiments may provide for significant improvements to the functioning of a network and/or to the functioning of the network entities within the network, or the user equipment communicating with the network. For example, the above embodiments may be scalable in terms of switching time. The radio frequency retuning, for example, may minimize the time in which the UE may not be able to transmit or receive data. This allows for minimizing the length of time when the UE may receive downlink signal with bandwidth exceeding the network entity Tx BW, thereby improving the efficiency and resource usage of the network. Radio frequency retuning may be triggered without uplink grant, in certain embodiments. Some of the above embodiments may be robust against signaling errors, as well as allowing for fast resynchronization after BWP switching or retuning the radio frequency. Certain embodiments may also support different LBT approaches. The above advantages and improvements help to reduce network resource usage, and allow for more efficient network transmission and processing.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. Although the above embodiments refer to 5G NR and LTE technology, the above embodiments may also apply to any other present or future 3GPP technology, such as LTE-advanced, and/or fourth generation (4G) technology.

Partial Glossary

ACK Acknowledgement

BW Bandwidth

BWP Bandwidth Part

CA Carrier Aggregation

CC Component Carrier

CCA Clear Channel Assessment

COT Channel Occupancy Time

CSI-RS Channel State Information Reference Signal

DCI Downlink Control Information

DL Downlink

DMRS Demodulation Reference Signal

eNB enhanced Node B (LTE base station)

FDMA Frequency Division Multiple Access

FFT Fast Fourier Transformation

gNB 5G or NR base station

HARQ Hybrid Automatic Repeat Request

LAA Licensed Assisted Access

LBT Listen Before Talk

LTE Long Term Evolution

MCS Modulation and Coding Scheme

NR New Radio

NR-U New Radio Unlicensed

OFDM Orthogonal Frequency Domain Multiplexing

PDCCH Physical Downlink Control Channel

PDSCH Physical Downlink Shared Channel

PUCCH Physical Uplink Control Channel

PUSCH Physical Uplink Shared Channel

RF Radio Frequency

RRC Radio Resource Control

SCS Subcarrier Spacing

UE User Equipment

UL Uplink

1. An apparatus comprising:
at least one memory comprising computer program code; and
at least one processor;
wherein the at least one memory and the computer program code are configured, with the at least one processor, to cause the apparatus at least to:
determine a need for retuning a radio frequency based on a received downlink transmission bandwidth;
determine a time for the retuning of the radio frequency;
retune the radio frequency at the determined time; and
transmit data to a network entity using the retuned radio frequency.

2. The apparatus according to claim 1, wherein the time is determined based on a structure of a transmission burst or an indication received from the network entity.

3. The apparatus according to claim 2, wherein the time for the retuning of the radio frequency starts at the end of the first downlink portion of the transmission burst.

4. The apparatus according to claim 2, wherein the structure of the transmission burst includes two or more downlink, one or more uplink transmission portions, and corresponding switching gaps.

5. The apparatus according to claim 2, wherein the indication is explicit or implicit.

6. The apparatus according to claim 1, wherein the time for the retuning of the radio frequency occurs after one or more adjacent downlink slots.

7. The apparatus according to claim 1, wherein the time for the retuning of the radio frequency aligns with retuning performed by another user equipment.

8. The apparatus according to claim 1, wherein the at least one memory and the computer program code are configured, with the at least one processor, to cause the apparatus at least to:
receive a downlink transmission on a bandwidth from the network entity.

9. The apparatus according to claim 8, wherein the receiving of the downlink transmission triggers the retuning of the radio frequency.

10. The apparatus according to claim 1, wherein the at least one memory and the computer program code are configured, with the at least one processor, to cause the apparatus at least to:
receive a reference signal or a preamble for resynchronization of a user equipment before a next downlink portion of a transmission burst.

11. The apparatus according to claim 1, wherein the need for the retuning of the radio frequency occurs when a bandwidth part of the user equipment is not included within a downlink bandwidth part of the network entity or when the bandwidth part of the user equipment is only partially included within the downlink bandwidth part of the network entity.

12. The apparatus according to claim 1, wherein the user equipment does not perform any uplink transmissions before or during the retuning of the radio frequency.

13. An apparatus comprising:
at least one memory comprising computer program code; and
at least one processor;
wherein the at least one memory and the computer program code are configured, with the at least one processor, to cause the apparatus at least to:
determine at a network entity a time for retuning a radio frequency at a user equipment;
indicate the time for the retuning of the radio frequency to the user equipment; and
receive data at the network entity from the user equipment using the retuned radio frequency.

14. The apparatus according to claim 13, wherein the time comprises at least one of a start time and a length of time for the retuning of the radio frequency at the user equipment.

15. The apparatus according to claim 13, wherein the time for the retuning of the radio frequency aligns with retuning performed by another user equipment.

16. The apparatus according to claim 13, wherein the at least one memory and the computer program code are configured, with the at least one processor, to cause the apparatus at least to:
perform either a type 2 listen before talk or no listen before talk before a second downlink portion of a transmission burst.

17. The apparatus according to claim 13, wherein the at least one memory and the computer program code are configured, with the at least one processor, to cause the apparatus at least to:
transmit to the user equipment a downlink transmission on a bandwidth, wherein the downlink transmission triggers the retuning of the radio frequency.

18. The apparatus according to claim 13, wherein the at least one memory and the computer program code are configured, with the at least one processor, to cause the apparatus at least to:
transmit to the user equipment a reference signal or a preamble for resynchronization of the user equipment before a next downlink portion of a transmission burst.

19. The apparatus according to claim 13, wherein the time for the retuning of the radio frequency occurs after one or more adjacent downlink slots.

20. A method comprising:
determining at a user equipment a need for retuning a radio frequency based on a received downlink transmission bandwidth;
determining at the user equipment a time for the retuning of the radio frequency;
retuning the radio frequency at the determined time; and
transmit data from the user equipment to a network entity using the retuned radio frequency.

21. The method according to claim 20, wherein the time is determined based on a structure of a transmission burst or an indication received from the network entity.
